(19) United States
(12) Patent Application Publication
(10) Pub. No.: US 2012/0217207 A1
(43) Pub. Date: Aug. 30, 2012

(54) WATER PURIFICATION SYSTEM

(75) Inventors: Micah C. Bowen, South Windsor, CT (US); Joseph R. Conti, Stormville, NY (US); Amanda L. Fortus, Cranford, NJ (US); Andrew M. Labrie, Westfield, MA (US); Robert T. Gettens, Longmeadow, MA (US); James C. McKeon, Longmeadow, MA (US); Glenn E. Vallee, Westbrook, MA (US)

(73) Assignee: WESTERN NEW ENGLAND UNIVERSITY, Springfield, MA (US)

(21) Appl. No.: 13/403,165

(22) Filed: Feb. 23, 2012

Related U.S. Application Data
(60) Provisional application No. 61/446,112, filed on Feb. 24, 2011.

(51) Int. Cl. C02F 1/32; B01D 17/00

(52) U.S. Cl. 210/748.11; 210/251

(57) ABSTRACT

A water treatment system is provided. The system includes a container having a removably coupled cover. A conduit is coupled to the cover. At least one UV germicidal light bulb is coupled to the conduit, wherein the conduit and at least one UV germicidal light bulb cooperate to arranged the at least one UV germicidal light bulb to be within the container when the cover is coupled to the container. A funnel is coupled to the cover opposite the at least one UV germicidal bulb. A filter is coupled to the cover and fluidly coupled to the funnel, the filter arranged to be within the container when the cover is coupled to the container. At least one electrical generator is configured to couple with a bicycle frame, the at least one electrical generator being electrically coupled to provide electrical power to the at least one UV germicidal bulb.

### BACKGROUND OF THE INVENTION

The present application claims the benefit of U.S. Provisional Application, Ser. No. 61/446,112, filed Feb. 24, 2011, the contents of which is incorporated by reference herein.

The subject matter disclosed herein relates to a water purification system and in particular to a water purification system with two stages of purification that is powered by a bicycle.

Having access to clean water is desirable to healthy living. Unclean or dirty water can lead to illness and may be potentially fatal. It has been estimated that over 1.1 billion people in developing countries lack access to clean water. There are many different ways to purify water, including boiling, chemicals, or UV light. Boiling is the most popular method of purifying water. The issue with boiling is the amount fuel, whether it be electricity, wood, gas or chemicals for example, that is required to heat the water. Fuel is expensive and therefore a problem for families living developing or third world countries. Further, existing water purification systems are expensive to purchase, operate and maintain.

While existing water treatment systems are suitable for their intended purposes a need to improvement remains, particularly in the providing of an inexpensive water treatment system that is able to kill bacteria and viruses in addition to contaminants such as dirt or sand.

### BRIEF DESCRIPTION OF THE INVENTION

According to one aspect of the invention, a water treatment system is provided. The system includes a container and a cover removably coupled to the container. A conduit is coupled to the cover. At least one UV germicidal light bulb is coupled to the conduit, wherein the conduit and at least one UV germicidal light bulb cooperate to arranged the at least one UV germicidal light bulb to be within the container when the cover is coupled to the container. A funnel is coupled to the cover opposite the at least one UV germicidal bulb. A filter is coupled to the cover and fluidly coupled to the funnel, the filter arranged to be within the container when the cover is coupled to the container. At least one electrical generator is configured to couple with a bicycle frame, the at least one electrical generator being electrically coupled to provide electrical power to the at least one UV germicidal bulb.

According to another aspect of the invention, a water treatment system powered by a bicycle is provided. The water treatment system includes a stand having at least one coupler configured to suspend a driven wheel of the bicycle to rotate freely. At least one generator is removably coupled to the bicycle. A filtration system is disposed adjacent the stand. The filtration system includes a funnel and a filter fluidly coupled to the funnel A container is fluidly coupled to the filter. At least one power converter is electrically coupled to the at least one generator. At least one UV light bulb is electrically coupled to the at least one power converter, the at least one UV light bulb being disposed to emit ultraviolet light into water within the container.

According to yet another aspect of the invention, a method of purifying water is provided. The method includes the steps of coupling a bicycle to a stand to allow a driven wheel to rotate freely. A generator is coupled to the bicycle frame, the generator being arranged to rotate in response to rotation of the driven wheel. A container is provided with a cover having a funnel on one side and a active carbon filter on an opposite side, the filter being fluidly coupled to the funnel, the cover further having at least one UV germicidal light bulb operably coupled adjacent the filter. Water is poured into the funnel Sediment is filtered from the water. The bicycle is pedaled for a predetermined amount of time. The at least one UV germicidal light bulb is powered when the bicycle is being pedaled.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view illustration of a water treatment system in accordance with an embodiment of the invention;

FIG. 2 is another perspective view illustration of the water treatment system of FIG. 1;

FIG. 3 is a perspective view illustration of a bicycle stand for use with the water treatment system of FIG. 1;

FIG. 4 is a partial perspective view illustration of a bicycle electrical generator arrangement for the water treatment system of FIG. 1;

FIG. 5 is a partial perspective view illustration of a bicycle mounted to the stand of FIG. 3;

FIG. 6 is a perspective view illustration of the water container and purifier assembly for the water treatment system of FIG. 1;

FIG. 7 is a perspective view illustration of a portion of the water container and purifier assembly of FIG. 6; and,

FIG. 8 is a perspective view illustration of the AC/DC power converter for use in the water container and purifier assembly of FIG. 6.

The detailed description explains embodiments of the invention, together with advantages and features, by way of example with reference to the drawings.

### DETAILED DESCRIPTION OF THE INVENTION

Access to pure water is desirable to prevent the contracting of diseases that may lead to illness or death. A portable mechanically powered water purification system is provided that provides advantages in being easy to use, low in cost, and high in effectivity and durability. The purification system may be transported to the location it is needed making it easier for users to purify their water in a convenient place. The purification system is able to treat sufficient water for a two people for an entire day in a short period of time.

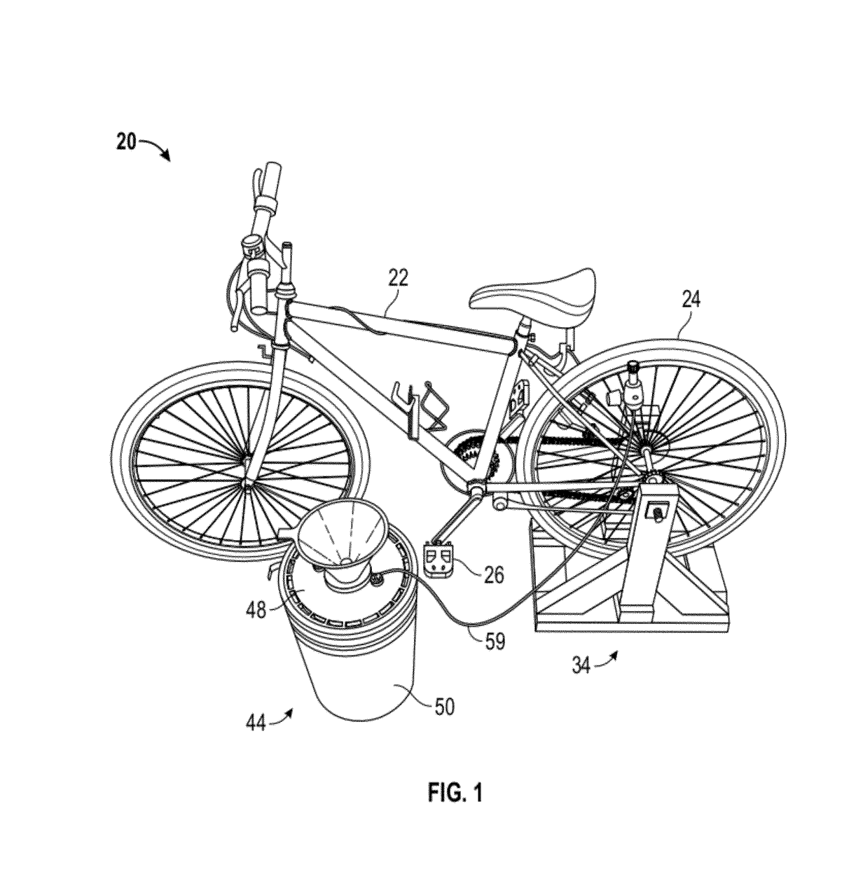

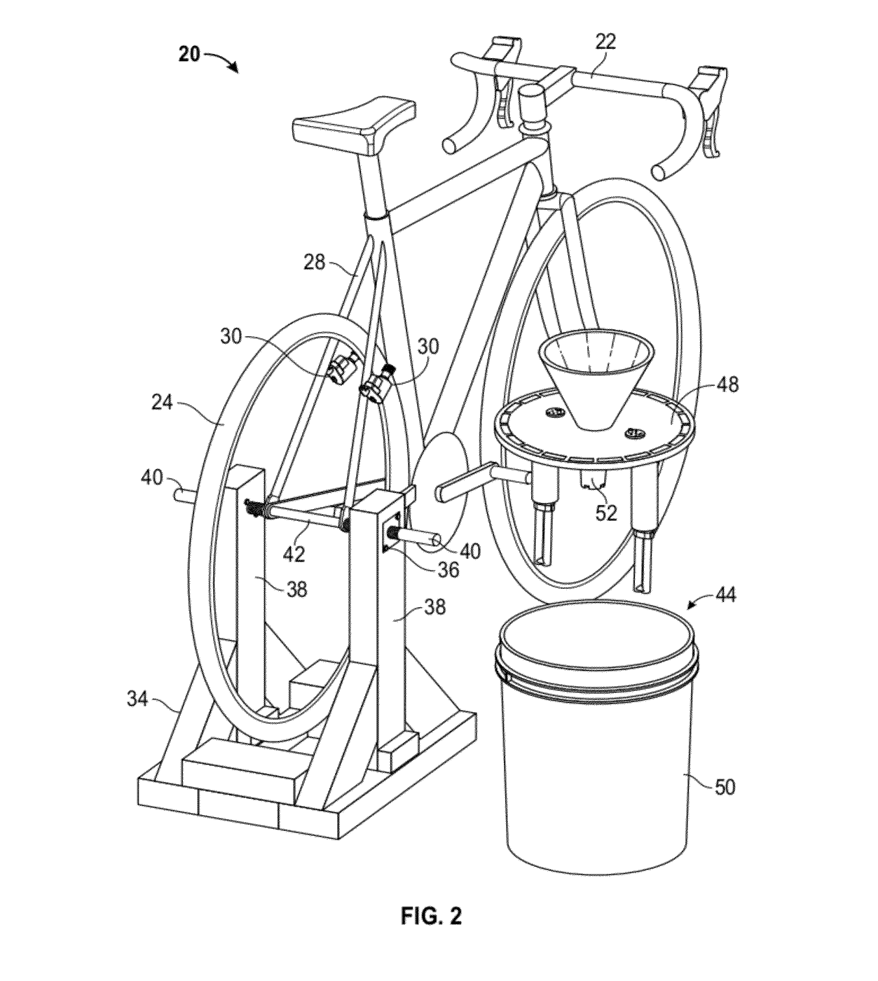

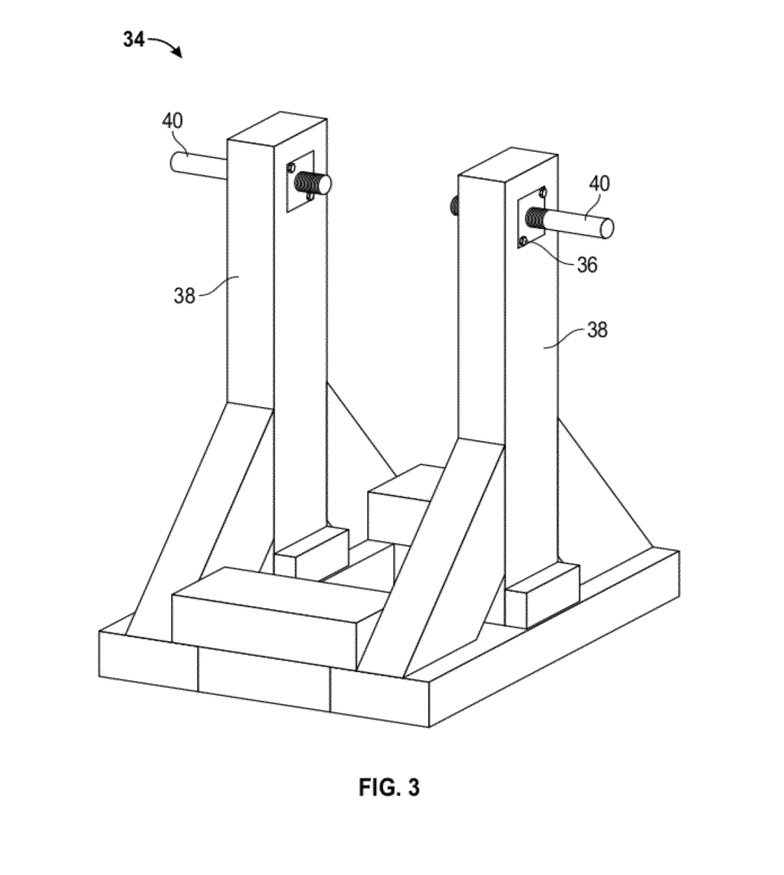

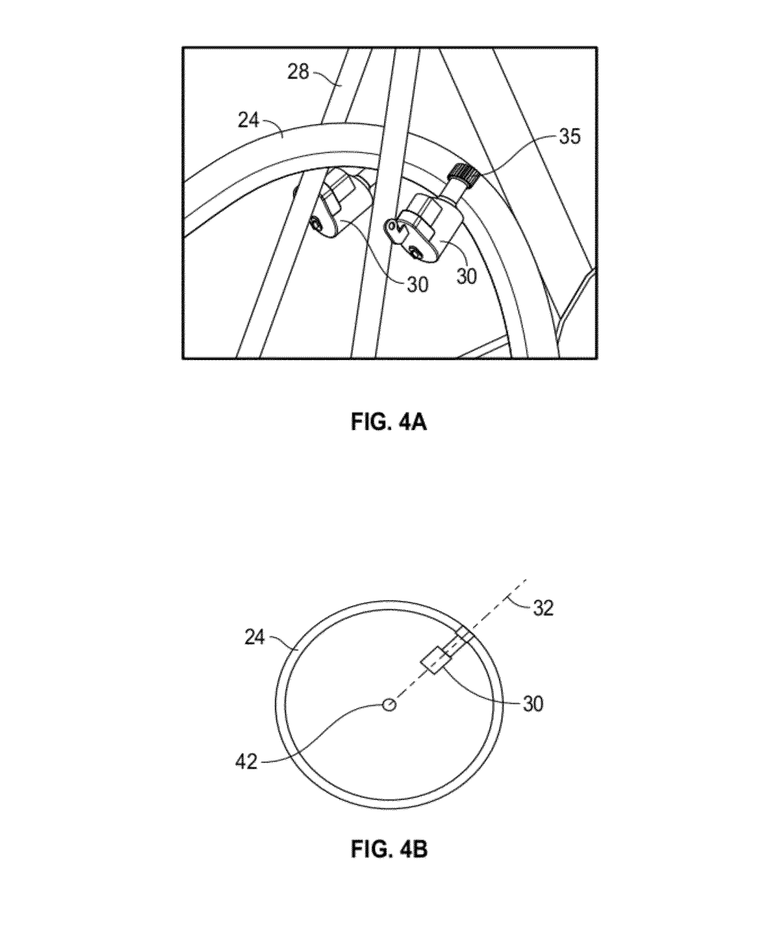

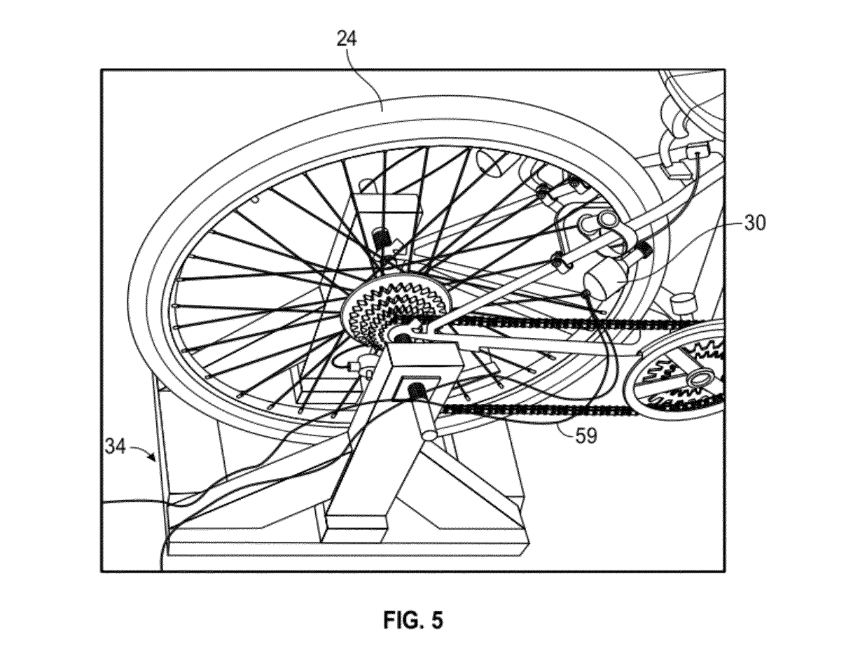

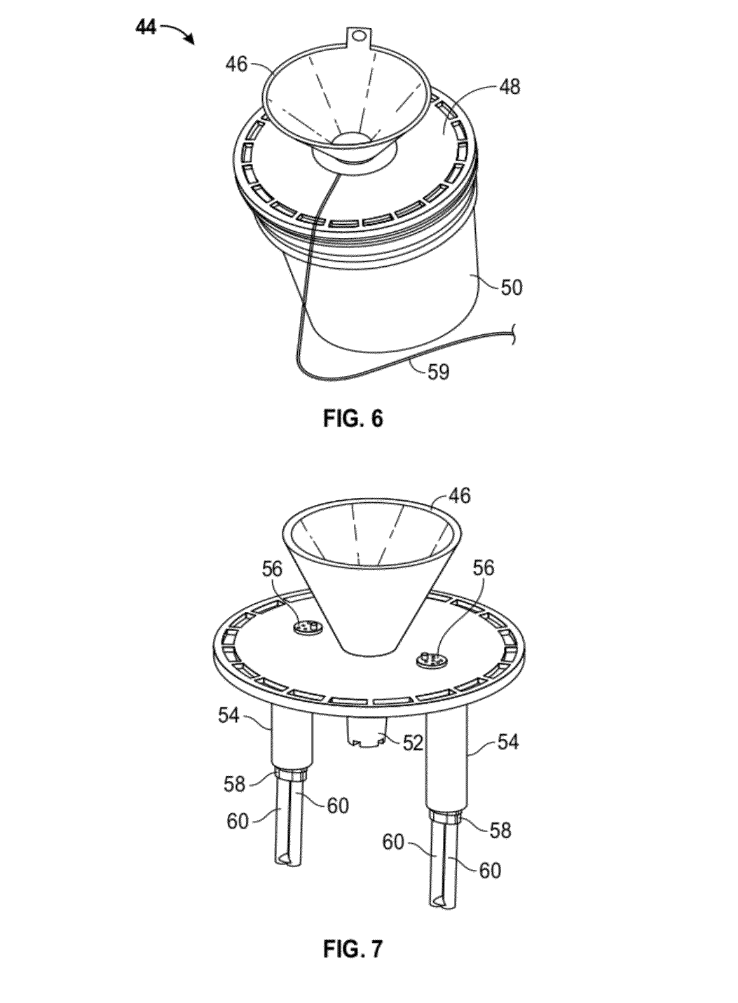

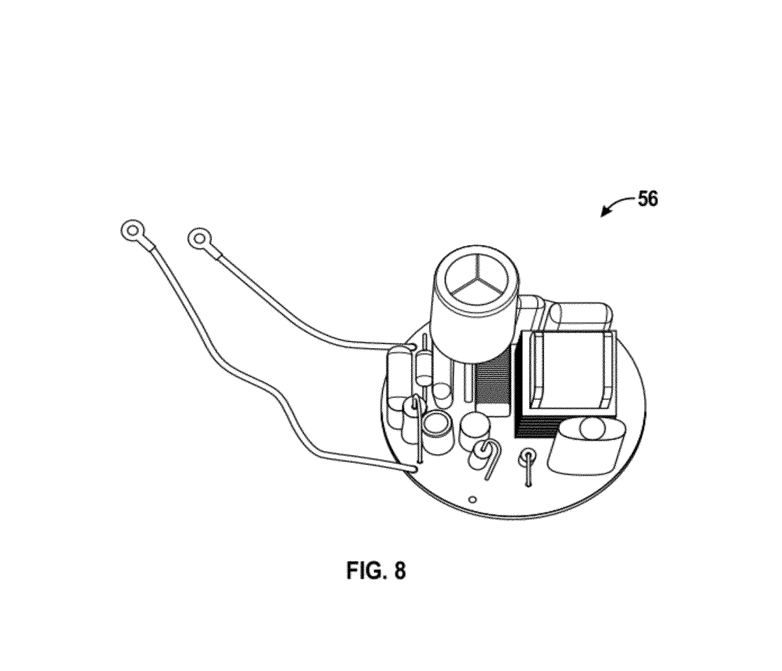

An exemplary embodiment of a water purification system 20 is shown in FIGS. 1-8. The purification system 20 includes a bicycle 22 having a driven wheel 24 suspended above the ground to keep the bicycle 22 stationary while an operator pushing on the bicycle pedals 26 rotates the wheel 24. Attached to the bicycle frame 28 is a pair of dynamo generators 30 located on opposite sides of the wheel 24. In one embodiment, the longitudinal axis of the generators 30 lies on a radial line 32 passing through the axis of the wheel 24 as shown in FIG. 4B. This provides advantages in reducing friction forces within the generator 30 and therefore provides advantages in increasing efficiency.

Each generator 30 include a roller 35 that rests against the side-wall of the wheel 24. As the wheel 24 is rotated, the roller 35 rotates due to the friction between the wheel and the roller. The rotation of the roller 35 in turn rotates a dynamo to generate electricity. In the exemplary embodiment, the generators 30 generate at least 12 volts-6 watts of electrical power when the bicycle pedal is rotated at 60 rotations per minute. In one embodiment, the generator 30 may be a Dymotec S12 manufactured by Busch-Muller Company.

The bicycle wheel 24 is suspended by a stand 34. In the exemplary embodiment, the stand 34 uses approximately 15 feet (4.57 meters) of lumber with the standard cross section of 2 inches by 4 inches (5.1 centimeters by 10.2 centimeters) Within in the stand 34 are two 2 inches by 2 inches by 0.5 inches (5.1 cm by 5.1 cm by 1.27 cm) steel blocks 36 that are drilled and tapped for a ¾-10 thread (M12×1.5 metric thread). The two steel blocks 36 sit flush with the outside edge of the two main vertical bike supports 38. There are two 6 inch by ¾ inch steel rods 40 that are threaded with a length of 4″. The threaded end includes a bored half inch diameter hole to a depth of ¾″. The bicycle 22 rear axle nuts (not shown) are removed and the axle 42 is lined up with the bored hole at the end of the steel rods 40. The rods 40 are then tightened till overlapping the axle 42 and compressing the frame 28 of the bicycle 22.

Arranged adjacent the bicycle 22 is a filtration system 44. The filtration system 44 includes a funnel 46 that holds and directs water provided by the user. The funnel 46 is coupled to a cover 48 that is sized to be removably coupled to a container 50. The funnel 46 directs the water provided by the user through cover 48 into a filter 52. In the exemplary embodiment, the filter 52 is an activated carbon filter, such as a Brita® water filter manufactured by The Clorox Company. The water enters filter 52 on an end adjacent the cover 48 and flows out an opposite end into the container 50. The filter 52 removes particulate contaminants from the water provided by the user, such as but not limited to chlorine, volatile organic compounds, toxic metals and other sediment. In one embodiment, the filter 52 may remove approximately 99.9% of dirt, sand and larger debris. In the exemplary embodiment, the filter 52 is sized to treat approximately 40 gallons of water. As will be discussed below, the filter increases the efficiency of a UV-C germicidal bulb. If the sediment remained in the water, the contamination could block the penetration of the UV rays to any bacteria or virus suspended in the water.

A pair of power converters 56 are coupled to the cover 48 and are arranged to receive electrical power from the generators 40 by a wiring harness 59 for example. The power converters 56 adapt the output of the generator 40 to have the electrical characteristics (e.g. converts from DC to AC electricity) needed for a UV-C germicidal bulb as will be described in more detail below. It should be appreciated that while the power converters 56 are shown coupled to the cover, they may be arranged in any other convenient location, such as on the generators 30 for example. Coupled to the cover 48 opposite the filter 46 are two conduits 54. In the exemplary embodiment, the conduits are six inch polyvinyl chloride (PVC) pipe.

The conduits 54 have a hollow interior that allows an electrical connection between an power converter 56 and an electrical bulb base 58 disposed on an end of the conduit 54. In one embodiment, the bulb base 58 is a G23 two pin florescent bulb bases. In the exemplary embodiment, the connection between the conduit 54 and the base 58 is sealed to inhibit the infiltration of water into the conduit 54. Two UV-C germicidal bulbs 60 are then coupled to the bulb base 58. In the exemplary embodiment, the bulbs 60 are a 7W UV-C germicidal bulbs such as a model GPX7 bulb manufactured by Ushio America, Inc. The conduits 54 off set the bulbs 60 from the cover 48 such that the bulbs 60 are disposed in the container 50 at a level where the bulbs 60 are submerged within the filtered water. In the exemplary embodiment, the bulbs 60 are sized and configured to treat water for 8000 hours of use. In one embodiment, the bulbs 60 will kill 99.9% of all disease causing bacteria and viruses.

During operation, the user connects the bicycle 22 to the stand 34 as described above. The user then provides water, such as that obtained from a local well or river for example, and pours it into the funnel 46. In the exemplary embodiment, the user provides approximately 4.6 gallons of water. The water flows through the funnel 46 and the filter 52 where contaminants such as sediment are removed. The user then mounts the bicycle and pedals at a desired rate to provide sufficient electrical power to the bulbs 60. In the exemplary embodiment, the user pedals at approximately 60 rpm to power the bulbs 60 for approximately eight minutes. The bulbs 60 emit ultraviolet light into the filtered water to kill disease causing bacteria and viruses. Powering the bulbs 60 for eight minutes will produce 4.6 gallons of cleaned water. After the bulbs 60 have been powered for the desired amount of time, the user may remove the cover 50 and transfer the cleaned water to a desired storage container. This process may then be repeated as needed to obtain the desired amount of water. In one embodiment, the operator may be provided with a testing kit to verify the potability of the purified water.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A water treatment system comprising:
a container;
a cover removably coupled to the container;
at least one UV germicidal light bulb fluidly coupled to the container, wherein the at least one UV germicidal light bulb is disposed within the container when the cover is coupled to the container; and,
at least one electrical generator configured to couple with a bicycle frame, the at least one electrical generator being electrically coupled to provide electrical power to the at least one UV germicidal bulb.

2. (canceled)

3. (canceled)

4. The water treatment system of claim 1 further comprising a funnel coupled to the cover opposite the at least one UV germicidal bulb.

5. The water treatment system of claim 4 further comprising a filter coupled to the cover and fluidly coupled to the funnel.

6. The water treatment system of claim 5 wherein the filter is disposed within the container when the cover is coupled to the container.

7. The water treatment system of claim 1 further comprising a conduit coupled between the cover and the container, wherein the conduit and at least one UV germicidal light bulb cooperate to arranged the at least one UV germicidal light bulb to be within the container when the cover is coupled to the container.

8. A water treatment system powered by a bicycle comprising:
a stand having at least one coupler configured to suspend a driven wheel of the bicycle to rotate freely;
at least one generator removably coupled to the bicycle;
a filtration system disposed adjacent the stand, the filtration system including:
a container fluidly coupled to the filter; and
at least one UV light bulb electrically coupled to the at least one generator, the at least one UV light bulb being disposed to emit ultraviolet light into water within the container.

9. The water treatment system of claim 8 further comprising a funnel having one end fluidly coupled to the container.

10. The water treatment system of claim 9 further comprising a filter fluidly coupled to the funnel.

11. The water treatment system of claim 10 wherein the filter is fluidly coupled between the funnel and the container.

12. The water treatment system of claim 8 wherein the at least one generator is configured to be rotated by a bicycle tire.

13. The water treatment system of claim 8 further comprising a power converter electrically coupled between the at least one generator and the at least one UV light bulb.

14. A method of purifying water comprising:
coupling a bicycle to a stand to allow a driven wheel to rotate freely;
coupling a generator to the bicycle frame, the generator being arranged to rotate in response to rotation of the driven wheel;
providing a container with a cover, the cover further having at least one UV germicidal light bulb operably coupled adjacent the filter;
pedaling the bicycle for a predetermined amount of time; and, powering the at least one UV germicidal light bulb when the bicycle is being pedaled.

15. The method of claim 14 further comprising:
providing a funnel fluidly coupled to one side of the cover; and
providing an active carbon filter on an opposite side of the cover, the filter being fluidly coupled to the funnel.

16. The method of claim 15 further comprising pouring water into the funnel.

17. The method of claim 16 further comprising filtering sediment from the water with the filter.

18. The method of claim 14 further comprising operating the bicycle to power the at least one UV germicidal bulb for at least eight minutes.
